(19) United States
(12) Patent Application Publication
(10) Pub. No.: US 2015/0076102 A1
(43) Pub. Date: Mar. 19, 2015

(54) LIQUID CRYSTAL JAR FOR ONE DROP FILLING PROCESS

(71) Applicant: Shenzhen China Star Optoelectronics Technology Co. Ltd., Shenzhen, Guangdong (CN)

(72) Inventor: Chong Long, Shenzhen City (CN)

(73) Assignee: Shenzhen China Star Optoelectronics Technology Co., Shenzhen, Guangdong (CN)

(21) Appl. No.: 14/126,428

(22) PCT Filed: Sep. 30, 2013
(86) PCT No.: PCT/CN2013/084661

§ 371 Date: Dec. 15, 2013

(30) Foreign Application Priority Data
Sep. 13, 2013 (CN) 201310419529.2

(51) Int. Cl. G02F 1/13

(52) U.S. Cl. CPC G02F 1/1303
USPC 215/12.1; 428/34.1; 428/34.6; 428/35.7

(57) ABSTRACT

The present invention provides a liquid crystal jar for an ODF process, which includes: a jar body (2), a bladder (4) received in the jar body (2), a conduit (6) arranged in the bladder (4). The bladder (4) has an opening (44) and a receiving space (42) communicating with the opening (44). The bladder (4) is hermetically connected to the conduit (6) at the opening (44). Liquid crystal (8) is received and contained in the receiving space (42) of the bladder (4) and is guided out of the bladder (4) via the conduit (6). The bladder (4) is made of a flexible material that does not react with the liquid crystal. The receiving space (42) of the bladder (4) lessens with the reduction of the amount of the liquid crystal. The present invention arranges a bladder in a jar body to be hermetically connected to a conduit to effectively prevent air from entering liquid crystal, so as to avoid defect dropping of liquid crystal due to air existing in the liquid crystal and effectively raise the yield rate and quality of liquid crystal display panels.

### BACKGROUND OF THE INVENTION

1. Field of the Invention

The present invention relates to the field of liquid crystal panel manufacturing, and in particular to a liquid crystal jar for a one drop filling (ODF) process of liquid crystal.

2. The Related Arts

Liquid crystal displays have a variety of advantages, such as thin device body, low power consumption, and being free of radiation, and are thus of wide applications, such as mobile phone, personal digital assistant (PDA), digital camera, computer monitor, and notebook computer screen.

Most of the liquid crystal displays that are currently available in the market are backlighting liquid crystal displays, which comprise an enclosure, a liquid crystal panel arranged in the enclosure, and a backlight module mounted in the enclosure. The structure of a conventional liquid crystal panel is composed of a color filter (CF) substrate, a thin-film transistor (TFT) array substrate, and a liquid crystal layer arranged between the two substrates and the principle of operation is that a driving voltage is applied to the two glass substrates to control rotation of the liquid crystal molecules of the liquid crystal layer in order to refract out light emitting from the backlight module for generating images. Since the liquid crystal panel itself does not emit light, light must be provided from the backlight module in order to normally display images. Thus, the backlight module is one of the key components of a liquid crystal display. The backlight modules can be classified in two types, namely a side-edge backlight module and a direct backlight module, according to the site where light gets incident. The direct backlight module comprises a light source, such as a cold cathode fluorescent lamp (CCFL) or a light-emitting diode (LED), which is arranged at the backside of the liquid crystal panel to form a planar light source directly supplied to the liquid crystal display panel. The side-edge backlight module comprises an LED light bar, serving as a backlight source, which is arranged at an edge of a backplane to be located rearward of one side of the liquid crystal display panel. The LED light bar emits light that enters a light guide plate (LGP) through a light incident face at one side of the light guide plate and is projected out of a light emergence face of the light guide plate, after being reflected and diffused, to pass through an optic film assembly so as to form a planar light source for the liquid crystal display panel.

Referring to FIG. 1, a liquid crystal display generally comprises a CF substrate 100, a TFT array substrate 300, liquid crystal (LC) 500 interposed between the CF substrate 100 and the TFT array substrate 300, spacers 700, and a sealant 900 and the manufacturing process generally comprises a front stage of array process (including thin film, yellow light, etching, and film stripping), an intermediate stage of cell process (including bonding of TFT substrate and the CF substrate), and a rear stage of assembling process (including mounting of drive ICs and printed circuit board). The front stage of array process generally manufactures the TFT substrate in order to control the movement of liquid crystal molecules. The intermediate stage of cell process generally introduces liquid crystal between the TFT substrate and the CF substrate. The rear stage of assembling process generally mounts the drive ICs and combining the printed circuit board to effect driving the liquid crystal molecules to rotate for displaying images.

The conventional process of introducing liquid crystal between the TFT substrate and the CF substrate is generally a process referred to as one drop filling (ODF), which generally comprises processes of coating a resin frame, injecting liquid crystal, vacuum assembling, and high temperature curing, among which the process of injecting liquid crystal is often carried out by a distribution method or a vacuum injection method.

Referring to FIG. 2, which is a schematic view demonstrating an operation of a conventional ODF process. A dropping device 150 and a liquid crystal jar 350 collectively constitute an ODF device, wherein a measure of vacuum or pumping is applied to draw in a predetermined amount of liquid crystal each time, which is then dropped on a substrate 550 through a nozzle 450. At the moment when the liquid crystal is being dropped, the entire device is in a condition of fast moving. This often causes shaking of the liquid crystal contained in the liquid crystal jar 350 and thus air bubbles result. When an air bubble enters a liquid crystal conduit, abnormality of injection (injection of a large droplet or null injection) may occur in the nozzle 450, eventually causing abnormality of quality of a liquid crystal display panel showing mura or bubbles.

To prevent the air bubbles generated by the shaking of the liquid crystal jaw from entering the liquid crystal conduit, a common practice is to stop using the jar once the residue of liquid crystal remaining therein reaches a predetermined amount in order to enable re-mixing and filtering for removing the bubbles. This practice increases the frequency of replacing liquid crystal and thus may affect the difficult of controlling particles existing in the machine and this is generally of no effect in eliminating abnormality of liquid crystal injection caused by air bubbles entering the conduit.

### SUMMARY OF THE INVENTION

An object of the present invention is to provide a liquid crystal jar for a one drop filling process, which has a simple structure, can raise the utilization efficiency of liquid crystal, and can effectively improve abnormal situations of liquid crystal injection.

To achieve the above object, the present invention provides a liquid crystal jar for an ODF process, which comprises: a jar body, a bladder received in the jar body, and a conduit arranged in the bladder. The bladder comprises an opening and a receiving space communicating with the opening. The conduit has an end located close to a bottom of the receiving space of the bladder that is distant from the opening. The conduit has an opposite end extending out of the opening of the bladder. The bladder is hermetically connected to the conduit at the opening. Liquid crystal is received and contained in the receiving space of the bladder and is guidable out of the bladder via the conduit. The bladder is made of a flexible material that does not react with the liquid crystal. The receiving space of the bladder lessens with reduction of amount of the liquid crystal.

The jar body is made of a transparent material.

The jar body is made of glass.

The jar body is made of a clear plastic material.

The bladder is made of a transparent material.

The bladder is made of a thin sheet of material that has stable chemical properties.

The conduit is a circular tube of transparent plastics.

Further included is a cap. The jar body has a mouth and the cap is mounted to the mouth of the jar body. The opposite end of the conduit penetrates through the cap to project out of the jar body.

The opening of the bladder is located inside the mouth.

The present invention also provides a liquid crystal jar for an ODF process, which comprises: a jar body, a bladder received in the jar body, and a conduit arranged in the bladder, the bladder comprising an opening and a receiving space communicating with the opening, the conduit having an end located close to a bottom of the receiving space of the bladder that is distant from the opening, the conduit having an opposite end extending out of the opening of the bladder, the bladder being hermetically connected to the conduit at the opening, liquid crystal being received and contained in the receiving space of the bladder and being guidable out of the bladder via the conduit, the bladder being made of a flexible material that does not react with the liquid crystal, wherein the receiving space of the bladder lessens with reduction of amount of the liquid crystal;

wherein the jar body is made of a transparent material;

wherein the bladder is made of a transparent material; and

wherein the bladder is made of a thin sheet of material that has stable chemical properties.

The jar body is made of glass.

The jar body is made of a clear plastic material.

The conduit is a circular tube of transparent plastics.

Further included is a cap. The jar body has a mouth and the cap is mounted to the mouth of the jar body. The opposite end of the conduit penetrates through the cap to project out of the jar body.

The opening of the bladder is located inside the mouth.

The efficacy of the present invention is that the present invention provides a liquid crystal jar for an ODF process, which comprises a bladder arranged in a jar body and hermetically connected to a conduit to effectively prevent air from entering liquid crystal, so as to avoid defect drop of liquid crystal due to air existing in the liquid crystal and effectively raise the yield rate and quality of liquid crystal display panels and also to effectively reduce the frequency of replacement of liquid crystal, raise the utilization efficiency of liquid crystal, improve manufacture performance, and lower down manufacture cost.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic cross-sectional view showing a conventional liquid crystal display;

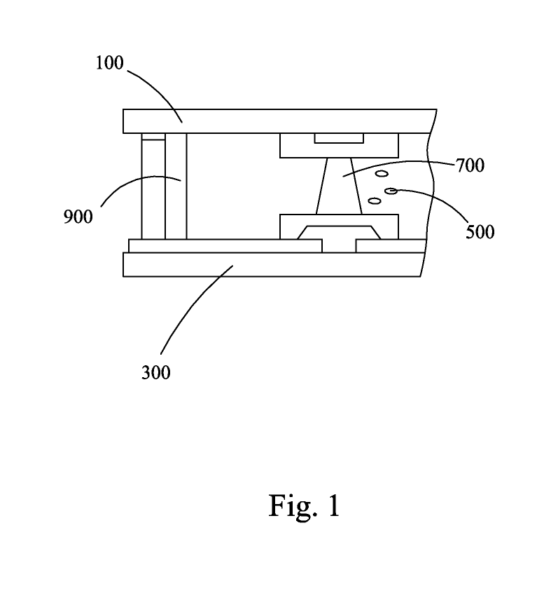

FIG. 2 is a schematic view demonstrating a conventional one drop filling (ODF) process of liquid crystal;

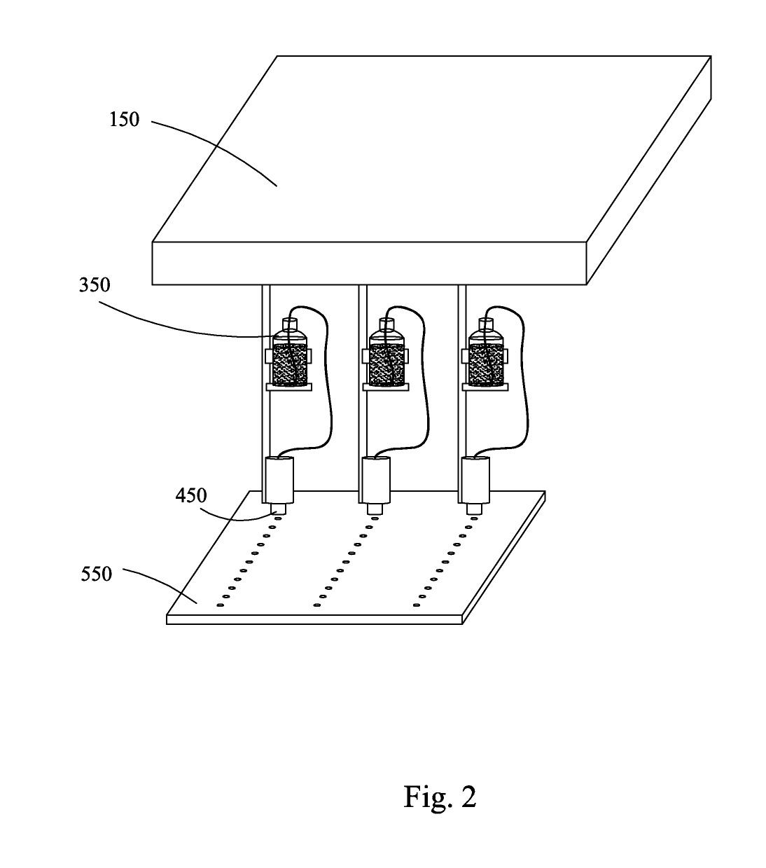

FIG. 3 is a perspective view showing a liquid crystal jar for an ODF process according to the present invention

FIG. 4 is a cross-sectional view showing the liquid crystal jar for an ODF process according to the present invention; and

FIG. 5 is a schematic view illustrating a condition where a receiving space of a bladder of the liquid crystal jar for an ODF process according to the present invention is reduced.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

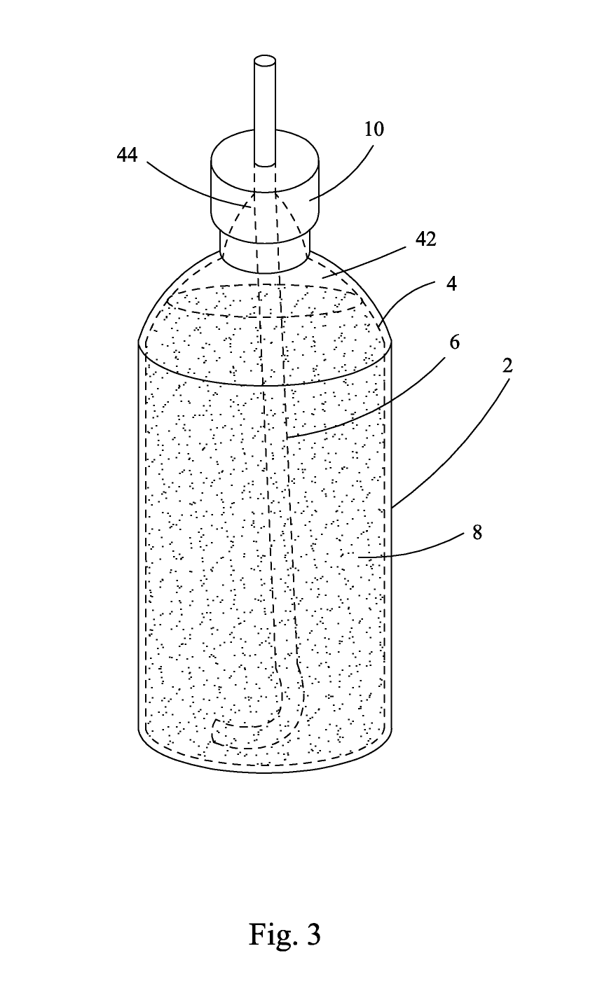

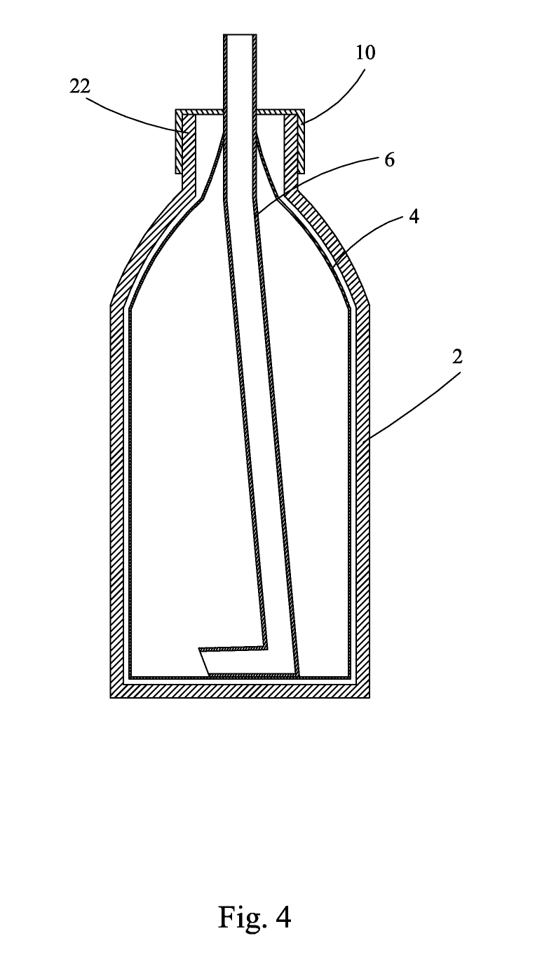

Referring to FIGS. 3 and 4, the present invention provides a liquid crystal jar for an ODF process, which comprises: a jar body 2, a bladder 4 received in the jar body 2, and a conduit 6 arranged in the bladder 4. The bladder 4 comprises an opening 44 and a receiving space 42 communicating with the opening 44. The conduit 6 has an end located close to a bottom of the receiving space 42 of the bladder 4 that is distant from the opening 44. The conduit 6 has an opposite end extending out of the opening 44 of the bladder 4. The bladder 4 is hermetically connected to the conduit 6 at the opening 44. Liquid crystal 8 is received and contained in the receiving space 42 of the bladder 4 and is guided out of the bladder 4 via the conduit 6. The bladder 4 is made of a flexible material that does not react with the liquid crystal 8. The receiving space 42 of the bladder 4 lessens with the reduction of the amount of the liquid crystal. Since the bladder 4 and the conduit 6 are hermetically connected, air is not allowed to enter the liquid crystal 8 so as to effectively prevent air from being mixed in the liquid crystal 8 and thus effectively avoid defect dropping of the liquid crystal caused by air existing in the liquid crystal 8 and effectively improve the yield rate and quality of liquid crystal display panels and also reduce the frequency of replacement of the liquid crystal 8, increase manufacturing performance, and lower down manufacture cost. The jar body 2 is made of a transparent material. Preferably, the jar body 2 is made of glass or clear plastic materials.

The bladder 4 is made of a transparent flexible material that does not react with the liquid crystal 8. Preferably, the bladder 4 is made of a thin sheet of material that has stable chemical properties.

In the instant embodiment, the conduit 6 is a circular tube of transparent plastics, having an end located close to the bottom of the receiving space 42 of the bladder 4 that is distant from the opening 44 and an opposite end extending out of the opening 44 of the bladder 4. It is noted that the liquid crystal jar for an ODF process according to the present invention may further comprise a cap 10. The jar body 2 has a mouth 22 and the cap 10 is mounted on the mouth 22 of the jar body 2. The opposite end of the conduit 6 penetrates through the cap 10 to project out of the jar body 2. The opening 44 of the bladder 4 is located inside the mouth 22.

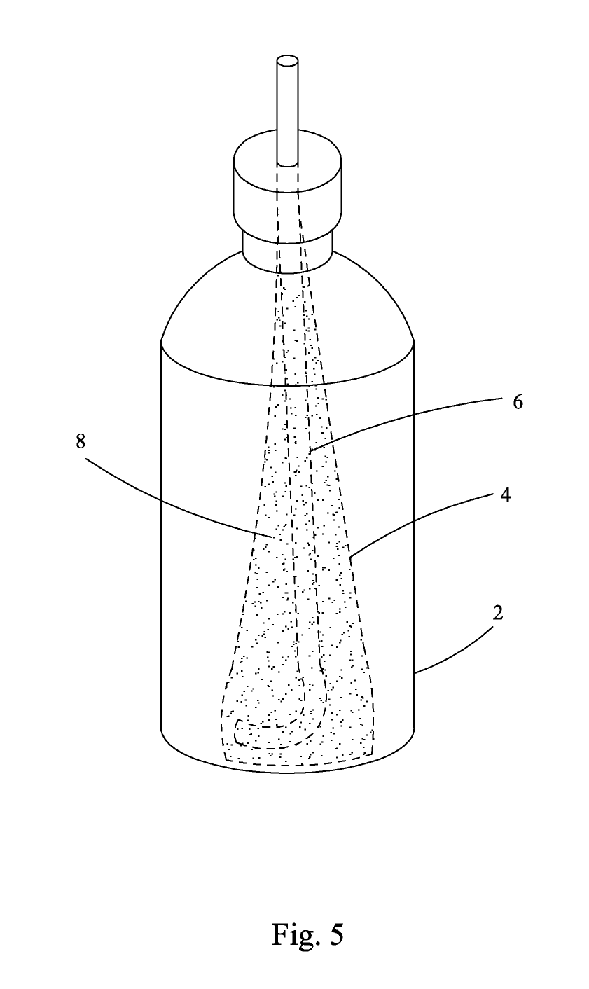

To use, the liquid crystal 8 is conducted out of the bladder 4 through the conduit 6. At the same time, air enters the jar body 2 through the cap 10. Due to the liquid crystal 8 being conducted out, partial vacuum forms in the bladder 4 and under the action of air pressure, the bladder 4 is shrunk (as shown in FIG. 5) so that at this moment, the internal pressure of the bladder 4 is the same as the external atmospheric pressure thereby ensuring the liquid crystal 8 can be smoothly injected through a nozzle (not shown) and the result of injection is identical to that achieved when the liquid crystal 8 is full and thus effectively ensuring the amount of drop of liquid crystal so as to effectively improve the yield rate of liquid crystal display panels (not shown). Further, since there is no air in the liquid crystal 8, it is possible to ensure that the liquid crystal 8 contained in the bladder 4 can be completely used up, avoiding the situation of frequently replacing the liquid crystal jar in due to the existence in the known techniques, thereby effectively improving the operation performance and lowering down the manufacture cost.

In summary, the present invention provides a liquid crystal jar for an ODF process, which comprises a bladder arranged in a jar body and hermetically connected to a conduit to effectively prevent air from entering liquid crystal, so as to avoid defect drop of liquid crystal due to air existing in the liquid crystal and effectively raise the yield rate and quality of liquid crystal display panels and also to effectively reduce the frequency of replacement of liquid crystal, raise the utilization efficiency of liquid crystal, improve manufacture performance, and lower down manufacture cost.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal jar for an ODF (One Drop Filling) process, comprising: a jar body, a bladder received in the jar body, and a conduit arranged in the bladder, the bladder comprising an opening and a receiving space communicating with the opening, the conduit having an end located close to a bottom of the receiving space of the bladder that is distant from the opening, the conduit having an opposite end extending out of the opening of the bladder, the bladder being hermetically connected to the conduit at the opening, liquid crystal being received and contained in the receiving space of the bladder and being guidable out of the bladder via the conduit, the bladder being made of a flexible material that does not react with the liquid crystal, wherein the receiving space of the bladder lessens with reduction of amount of the liquid crystal.

2. The liquid crystal jar for an ODF process as claimed in claim 1, wherein the jar body is made of a transparent material.

3. The liquid crystal jar for an ODF process as claimed in claim 2, wherein the jar body is made of glass.

4. The liquid crystal jar for an ODF process as claimed in claim 2, wherein the jar body is made of a clear plastic material.

5. The liquid crystal jar for an ODF process as claimed in claim 1, wherein the bladder is made of a transparent material.

6. The liquid crystal jar for an ODF process as claimed in claim 5, wherein the bladder is made of a thin sheet of material that has stable chemical properties.

7. The liquid crystal jar for an ODF process as claimed in claim 1, wherein the conduit is a circular tube of transparent plastics.

8. The liquid crystal jar for an ODF process as claimed in claim 1 further comprising a cap, the jar body having a mouth, the cap being mounted to the mouth of the jar body, the opposite end of the conduit penetrating through the cap to project out of the jar body.

9. The liquid crystal jar for an ODF process as claimed in claim 8, wherein the opening of the bladder is located inside the mouth.

10. A liquid crystal jar for an ODF process, comprising: a jar body, a bladder received in the jar body, and a conduit arranged in the bladder, the bladder comprising an opening and a receiving space communicating with the opening, the conduit having an end located close to a bottom of the receiving space of the bladder that is distant from the opening, the conduit having an opposite end extending out of the opening of the bladder, the bladder being hermetically connected to the conduit at the opening, liquid crystal being received and contained in the receiving space of the bladder and being guidable out of the bladder via the conduit, the bladder being made of a flexible material that does not react with the liquid crystal, wherein the receiving space of the bladder lessens with reduction of amount of the liquid crystal;
wherein the jar body is made of a transparent material;
wherein the bladder is made of a transparent material; and
wherein the bladder is made of a thin sheet of material that has stable chemical properties.

11. The liquid crystal jar for an ODF process as claimed in claim 10, wherein the jar body is made of glass.

12. The liquid crystal jar for an ODF process as claimed in claim 10, wherein the jar body is made of a clear plastic material.

13. The liquid crystal jar for an ODF process as claimed in claim 10, wherein the conduit is a circular tube of transparent plastics.

14. The liquid crystal jar for an ODF process as claimed in claim 10 further comprising a cap, the jar body having a mouth, the cap being mounted to the mouth of the jar body, the opposite end of the conduit penetrating through the cap to project out of the jar body.

15. The liquid crystal jar for an ODF process as claimed in claim 14, wherein the opening of the bladder is located inside the mouth.
